(19) United States
(12) Patent Application Publication
(10) Pub. No.: US 2015/0105146 A1
(43) Pub. Date: Apr. 16, 2015

(54) Sampling And Selection System For Video Games To Be Used In Arcade Game Consoles

(71) Applicant: Todd R. Stimac, Sun Prairie, WI (US)

(72) Inventor: Todd R. Stimac, Sun Prairie, WI (US)

(21) Appl. No.: 14/185,127

(22) Filed: Feb. 20, 2014

Related U.S. Application Data
(60) Provisional application No. 61/891,514, filed on Oct. 16, 2013.

(51) Int. Cl. A63F 13/79; G06Q 30/02; G07F 17/32

(52) U.S. Cl. CPC A63F 13/79; G07F 17/3227; G06Q 30/0201
USPC 463/29

(57) ABSTRACT

Disclosed are computer systems for selecting one or more arcade game candidates from a large collection of video games that were previously commercialized in other fields (such as in the form of mobile phone apps). There is a computer system having loaded therein software for controlling play of candidate video games, the computer system having the capability of being linked via a telecommunication system so as to permit sample portions of the video games to be played by game enthusiasts over the telecommunication system. After this sampling the computer system records game enthusiasts reactions. The reactions are then ranked so as to provide recommendations based on the winners of the election. Arcade games can then be produced based at least in part on the election results.

### CROSS-REFERENCE TO RELATED APPLICATION

This application claims priority based on U.S. provisional application 61/891,514 filed on Oct. 16, 2013.

### STATEMENT OF FEDERALLY SPONSORED RESEARCH OR DEVELOPMENT

Not applicable.

### BACKGROUND OF THE INVENTION

The present invention relates to computer systems that facilitate the evaluation and selection of video games for potential use in arcade game consoles. More particularly, it relates to computer systems that store video game software for candidate games being evaluated, permit game enthusiasts to sample playing portions of the games on-line, permit enthusiasts to then rate the sampled games on-line and otherwise respond to survey questions about the games, and then provide a report as to which games to prioritize for incorporation into arcade game consoles.

In the 1980's and 1990's many video games were designed for initial use in the arcade game market. Here, “arcade” is being used to refer a location where a cabinet-type game machine is positioned for use by enthusiasts, such as a bar, a casino, or a carnival-type game arcade. Most such arcades charged players to play the machines (e.g. via a cash per set of games payment, or via use of paid for tokens, or by activating the machines for a defined period such as fifteen minutes in response to payment). These arcades typically had multiple different types of machines at a single location, albeit some had only a single machine. Some machines enabled play of only one game. Others permitted enthusiasts to select among several possible games for play.

Such arcades sometimes were part of retail locations that also provided other services besides just game play (e.g. food; beverages; music). However, the focus of this patent is on the game machines.

With developments in technology, such as the home PC, the internet, the Wii system, the Nintendo system, other computer television systems, and mobile phone applications, some video games that were originally developed for the arcade game market had spin off versions developed that were suitable for these alternative markets. More recently, many video games were designed for use in the alternative technology markets, with little or no initial consideration regarding commercializing the game in an arcade type environment. For example, numerous video games are now being developed that are intended to be initially used as mobile phone applications (a/k/a “app(s)”). The person downloading an app from a supplier's site typically pays a single fee for perpetual use or use for a prolonged period such as a year.

Some of these mobile phone app “games” are likely to be of little or no value in the arcade market because of the nature of the app. For example, an app that merely generates a screen display that smiles and says “good morning” with a particular celebrity voice determined by spinning a roulette wheel depiction on the screen is likely to be a poor candidate as a pay for play arcade game. However, many other app video games may appear at first glance to be the type of game that might have commercial value in the arcade game market.

Even for games possibly suitable for the arcade game market, merely knowing that a game has become extremely popular as a mobile phone app (e.g. by checking the number of downloads) would not be determinative as to whether the game would be likely to be commercially successful in the arcade game market. For example, an extremely popular mobile app game may have already exhausted most of its commercial potential in the arcade market since the most likely enthusiasts would already have downloaded it onto their mobile phone (and thus be unwilling to pay even more to play at an arcade). On the other hand, the absence of significant mobile app success to date may simply mean that the public hasn't yet learned about the game.

Complicating matters, surveying the public as to their potential interest in playing even a single video game can be difficult. A representative sample of enthusiasts who are willing to participate in the survey may not have already had an opportunity prior to the survey to become sufficiently familiar with a game to provide a meaningful opinion. Further, in deciding which of numerous (possibly thousands) of candidate games to install in arcade game machines the issue isn't so much whether a potential customer likes the game enough to want to play again, but rather whether that player would choose that game over others if given the choice. Moreover, whatever an enthusiast's reaction to a video game might be in a mobile app environment, this doesn't necessarily predict whether the enthusiast would be willing to pay more to play, much less do so in an arcade environment.

Hence, a need exists for developing improved ways for evaluating the potential of pre-existing video games such as mobile phone game apps for the arcade game market.

### SUMMARY OF THE INVENTION

The present invention provides a computer system for selecting at least one video game from a plurality of (preferably more than ten; even more preferably more than one hundred) different game candidates for use in an arcade game machine. The computer system has stored therein software for controlling play of portions of each of the said plurality of different video games. The system has the capability of being linked to a telecommunication system (e.g. via the internet) so as to permit portions of the video games to be sample played by enthusiasts over the telecommunication system. The computer system also has the capability to record and compare reactions of those enthusiasts to the sample play of the video games, and then provide a report summarizing the reactions.

In one form the system can in essence conduct a form of election for commercial application. “Candidate” video games are queried by the “voters” in the form of briefly sampling game play of those games that they have the most initial interest in.

The system can also ask follow up questions testing enthusiasts' willingness to play the video games in an arcade setting versus via a phone app (e.g. How, if at all, would your response change if the inquiry related to play on an arcade game machine?). Similarly, the system can ask follow up questions testing enthusiasts' willingness to pay varying amounts for playing the video games in an arcade (e.g. How, if at all, would your response change if the arcade machine charged fifty cents (or one dollar) for each ten minutes of play?). The responses can then be factored into recommendations as to which games to try first in the arcade machine.

In another preferred form the computer system can hold a “primary” among a large number of candidate video games (e.g. ten to ten thousand), and then based on the results thereof hold a “final” election among a sub-group thereof (e.g. the top five rated candidates). This refinement is important because if there are hundreds (or even thousands) of potential game candidates few enthusiasts are likely to spend time learning about the games, and then sampling and responding with respect to all of them. A two tier approach allows the likely “cream” to first rise near the top, and then more of the public to be able to conduct a focused comparison by paying special attention to those candidates that are of the greatest interest.

The computer system can have a number of other refinements as well. For example, the system may reject multiple “votes” from the same e-mail address, and/or cap the number of votes from a particular zip code. This could help avoid having a game supplier (or those associated with the supplier) try to skew the results in favor of their candidate product.

As another refinement, the voting weight given to a particular response could be altered based on the time taken by a “voter” in sampling a game. For example, a favorable vote could be interpreted as two votes if the respondent played a sampled game for two minutes rather than forty-five seconds or less. The computer system could also be designed to entirely exclude responses to a game from those who did not sample that game for at least fifteen seconds.

In another aspect the invention provides a method of producing an arcade game machine. One uses the above computer system to select video game(s) for use in the arcade game machine. One then loads the selected game(s) in the arcade game machine for play.

The system could also be used for other commercial purposes. For example, it could generate a mailing list so that when a particular game that was highly favored by a sub-set of enthusiasts is introduced in the arcade market the most interested enthusiasts can be notified of retail machine locations near them. To respect privacy, enthusiasts can be given the option to opt in or out of this type of extra notification service.

In sum, the present invention provides an efficient way to sift through the numerous potential mobile app games. The system helps provide respondents with a bona fide basis for evaluations, and can be implemented at extremely low cost as compared to conventional in person market research. Further, the system has the additional advantage of being likely to encourage participation by the types of enthusiasts that are more likely to use arcade games, who sometimes are persons more comfortable with on-line communication than in person survey participation.

These and still other advantages of the present invention will become more apparent, and the invention will be better understood, by reference to the following description of preferred embodiments of the present invention.

### BRIEF DESCRIPTION OF THE DRAWINGS

FIG. 1 depicts video game apps running on several mobile phones;

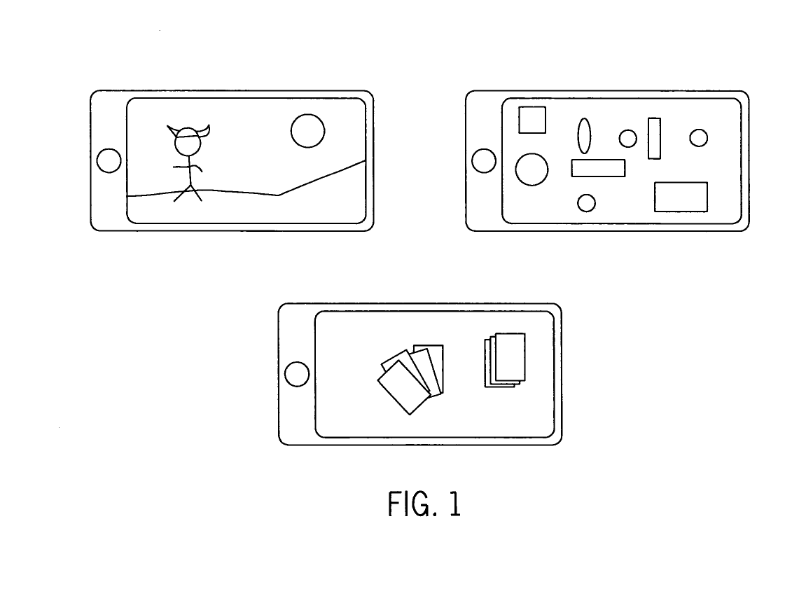

FIG. 2 is a schematic depiction of the process of loading portions of software for these games in a computer system capable of generating and operating a web site;

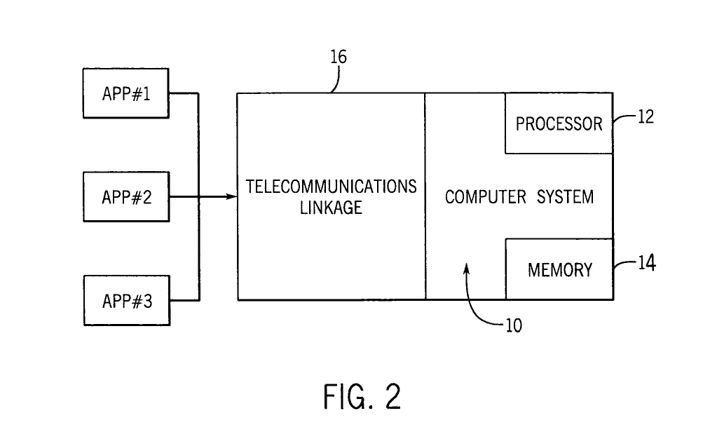

FIG. 3 is a flow chart representation of a system that records election results and survey responses, ranks games based thereon, and issues an election report based thereon; and

FIG. 4 depicts various arcade game machine consoles in which has been loaded games based on the election results as described above.

### DETAILED DESCRIPTION

The particular type of computer that is used to operate the computer system of the present invention is not critical. For example, the system could be run on a small scale on a home or office type computer (e.g. a Dell or HP computer), or on a more sophisticated computer. Such a computer 10 could have a processor 12, a memory 14, and telecommunications linkage 16.

One can link on-line to an app “store”, such as the Apple app store, and look for a few thousand or so possible mobile phone app candidates. One can then contact the listed suppliers to see if they are interested in participating. Those wishing to participate would provide a software copy of their game, or at least of enough code for a sample play portion of their game. This would then be loaded onto the preferred computer system.

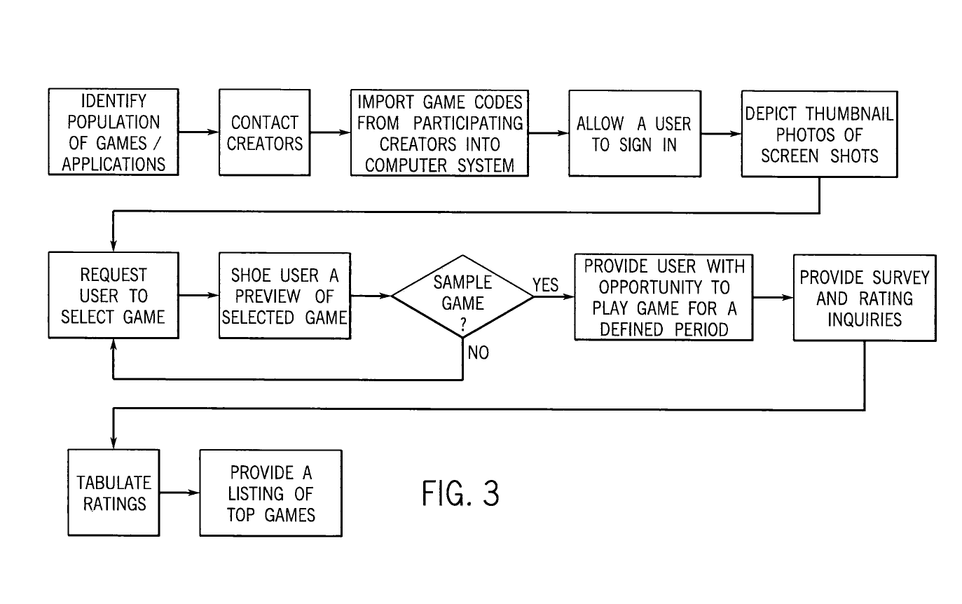

The computer system would then be provided with software that allows time limited sampling/play of games, plus the opportunity to record reactions and/or ask survey questions of the user. For example, as depicted in FIG. 3, after signing in an enthusiast could see a page (or several pages) of thumbnail screen shots from the games with a title and a sentence or two description for each game.

The order of the thumbnails would be randomly varied between respondents. By clicking on a thumbnail photo (when an enthusiast has initial interest), they could then trigger a ten second or so promotional video similar to what one might see on a game console screen when walking through an arcade. If the enthusiast is still interested, a further click would allow the game to be sampled (e.g. for a two minute period). Alternatively, the promotional video step need not be used. Once the sampling has occurred, a rating screen and/or survey form would be presented for that game.

After a statistically significant number of respondents have responded, the system would then generate a rating and/or ranking report. This can be used to help directly decide what to place in an arcade game machine console, or be first used to define top candidates that have survived the “primary” and now will be subjected to a final election.

The sampled game could merely be the full app game software, albeit governed by a two minute or so timer on play. Alternatively, it could be an edited/compressed selection of representative parts of each game.

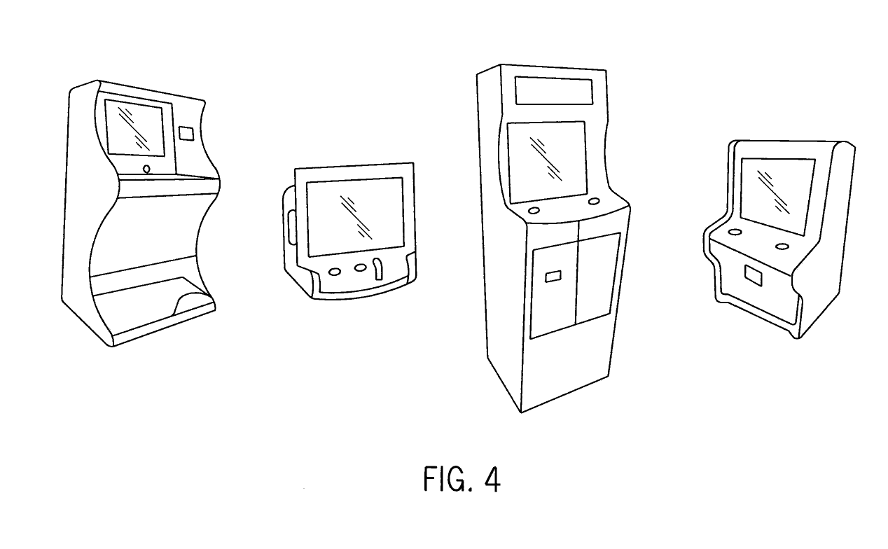

A wide variety of arcade game consoles are suitable for use with the present invention, as indicated by FIG. 4. Regardless, the invention can be used to expand the types of games loaded into arcade/bar game consoles, such as those consoles of Toccata Gaming International, so that instead of the consoles just playing something like their “Spooky Skillz” video slot game or their “9 Game” video package of games, they can also, or instead, be used to play additional video game candidates determined by the election. The games with the most indicated potential could be loaded in the machine in a manner similar to that currently used for loading these other video games.

As an example, if one wanted to compare relative commercial potential between the well known Angry Birds and Bad Piggies game apps, one could load both games (or portions thereof) on a computer system of the present invention. One could then provide thumbnail photos of a screen of both on an introduction screen, plus the opportunity to play a ten second or so promo for each. By clicking through the enthusiast would then have the ability to play each game for up to two minutes, and then rate both and provide survey responses for both.

The survey could have a series of further sophisticated screening capabilities to take into account possible outlier situations. For example, the question could be asked whether the respondent already has the app on their phone. If so, the responses could be ignored or discounted to some extent. Other questions could seek to determine if the respondent already has an unusually high number of video games on their phone, possibly indicating an enthusiast who doesn't carefully distinguish between games in a representative manner.

As yet a further refinement, one could place internet access capability in an such an amusement game machine. After a consumer plays whatever game is already in the machine the consumer can be offered the opportunity to link into the computer system of the present invention and provide feedback on other potential games. This approach helps insure that some respondents to the survey will be persons predisposed to playing arcade video games.

What has been described thus far are only the preferred embodiments of the invention. However, the invention is not to be so limited. For example, the term “video game” is intended to include a wide variety of interactive video entertainment, not necessarily just standard wagering (e.g. virtual slots; virtual blackjack) or non-wagering type games (virtual auto racing).

The claims should therefore be looked to in order to judge the full scope of the invention.

### INDUSTRIAL APPLICABILITY

The invention provides computer systems for sampling and selecting video games to be used in arcade game consoles, and arcade game consoles incorporating such games.

What is claimed is:

1. A computer system for selecting at least one video game from a plurality of different video game candidates for inclusion in an arcade game console, comprising:
a computer system having stored therein software for controlling play of at least portions said plurality of different video games;
said computer system having a capability of being linked to telecommunication system so as to permit the portions of the video games to be sampled and played by enthusiasts over the telecommunication system;
said computer system also having a capability to record and compare reactions of those enthusiasts to sample play of the portions of the video games; and
said computer system having a capability to provide a report summarizing said reactions.

2. The system of claim 1, wherein the reactions relate in part to an extent of willingness to play video games in an arcade.

3. The system of claim 1, wherein the reactions relate in part to an extent of willingness to pay to play video games.

4. The system of claim 1, wherein the computer system's report can rank video games.

5. The system of claim 1, wherein the computer system has a capability to hold a primary among a set of at least ten of said video games, and then based on results thereof hold a final election among a sub-group thereof.

6. The system of claim 3, wherein the system can facilitate an evaluation of an effect of changing a level of pay to play pricing on an extent of willingness to pay to play a video game.

7. A method of producing an arcade game machine, comprising:
using the computer system of claim 1 to facilitate selection of a video game for use in the arcade game machine; and
loading a selected game into the arcade game machine.
